(19) United States
(12) Patent Application Publication
(10) Pub. No.: US 2008/0163432 A1
(43) Pub. Date: Jul. 10, 2008

(54) Angler's utility tool

(75) Inventors: Tim L. Reid, Nicholasville, KY (US); William D. Fister, Nicholasville, KY (US)

Correspondence Address: MAGINOT, MOORE & BECK, LLP;CHASE TOWER, 111 MONUMENT CIRCLE, SUITE 3250, INDIANAPOLIS, IN, 46204, US

(73) Assignee: Buck 'n Beel Enterprises LLC, Nicholasville, KY (US)

(21) Appl. No.: 12/006,538

(22) Filed: Jan. 3, 2008

Related U.S. Application Data
(60) Provisional application No. 60/879,126, filed on Jan. 6, 2007.

(51) Int. Cl. B26B 11/00; B23F 21/03

(52) U.S. Cl. 7/120; 451/555

(57) ABSTRACT

An angler's utility tool that includes a line cutter and a sharpening stone has been developed to facilitate hook and lure exchanges. The angler's tool includes a first planar member, a second planar member, a lever arm, and a sharpening stone. The first planar member has a first end and a second end with the first end of the first planar member terminating into a first jaw. The second planar member has a first end and a second end with the first end of the second planar member terminating into a second jaw. The second ends of the first and the second planar members are joined to one another. A fulcrum pin extends through the first ends of the first and the second planar members. The lever arm is pivotally and rotationally mounted to the fulcrum pin, and the sharpening stone is mounted to the covering layer covering the portion of the second planar member. The sharpening stone may include a groove in a longitudinal edge to enable hook point sharpening.

### TECHNICAL FIELD

The tool described below relates to fishing tackle, and, more particularly, to fishing tackle used by sporting and recreational anglers.

### BACKGROUND

Most sporting and recreational anglers carry a tackle box with them. The tackle box contains supplies and tools that facilitate the setup of the fishing equipment and transitions between setups that may be necessary in light of encountered conditions. For example, most tackle boxes include various sizes of hooks, weights, and lures along with one or more pliers, screwdrivers, and sharpening stones. To change lures, for example, the knot that secures a lure currently being used may require cutting of a knot in the line to free the lure. To add the next lure to the line, the line must be threaded through the wire loop extending from the lure and an appropriate knot is then tied in the line to secure the lure to the line. Excess line must then be trimmed from the knot so the knot does not disturb the presentation of the lure in the water. Many anglers also examine the hooks attached to the lure to discover the condition of the hook points or barbs. Frequently, the points and barbs require reshaping with a sharpening stone to repair the barb or point.

During the above-described process, retrieval of the various tools needed to change the lure may be complicated by the organization of the tools in the tackle box as well as any pitching of the boat in which the angler is situated. Frequently, clippers resembling fingernail clippers are used to snip existing knots or to trim line from knots. The clippers are then returned to the tackle box so a search for a sharpening stone can commence. Once found, the sharpening stone is cradled in the angler's hand while the hook or hooks of the lure are stroked across the stone to apply an edge to the hook points or barbs. Transitions between tools provide opportunities for tools to be dropped onto a bank or into water or a boat. These transitions also take time and for some sporting anglers, the time spent changing equipment setups over the course of a day can make the difference between a frustrating day or a productive day. Consequently, tools that facilitate fishing tackle changes are beneficial.

### SUMMARY

An angler's utility tool that includes a line cutter and a sharpening stone has been developed to facilitate hook and lure exchanges. The angler's tool includes a first planar member, a second planar member, a lever arm, and a sharpening stone. The first planar member has a first end and a second end with the first end of the first planar member terminating into a first jaw. The second planar member has a first end and a second end with the first end of the second planar member terminating into a second jaw. The second ends of the first and the second planar members are joined to one another. Alternatively or additionally, a similar covering layer may be applied to the lever arm. A fulcrum pin extends through the first ends of the first and the second planar members. The lever arm is pivotally and rotationally mounted to the fulcrum pin. The sharpening stone is mounted to a bottom surface of the second planar member. Preferably, the sharpening stone is mounted to bracket, which is mounted to the second planar member with a securing member, such as a screw. The sharpening stone may also include one or more grooves in its longitudinal edge or edges to enable hook point sharpening.

### BRIEF DESCRIPTION OF THE DRAWINGS

Features of the utility tool are apparent to those skilled in the art from the following description with reference to the drawings, in which:

FIG. 1 is a perspective view of one embodiment of an angler's tool shown in a position for cutting fishing line.

FIG. 2 is a side view of the embodiment shown in FIG. 1.

FIG. 3 is a cross-sectional view of the embodiment of the angler's tool shown in FIG. 1 taken along lines 3-3.

FIG. 4 is a cross-sectional view of the sharpening stone taken along lines 4-4 of the tool shown in FIG. 1.

FIG. 5 is a bottom plan view of the embodiment shown in FIG. 1 depicting movement of the knife blade.

FIG. 6 is a bottom perspective of a preferred embodiment having a replaceable sharpening stone.

FIG. 7 is a tilted perspective view of the replaceable stone within a holding bracket.

### DETAILED DESCRIPTION

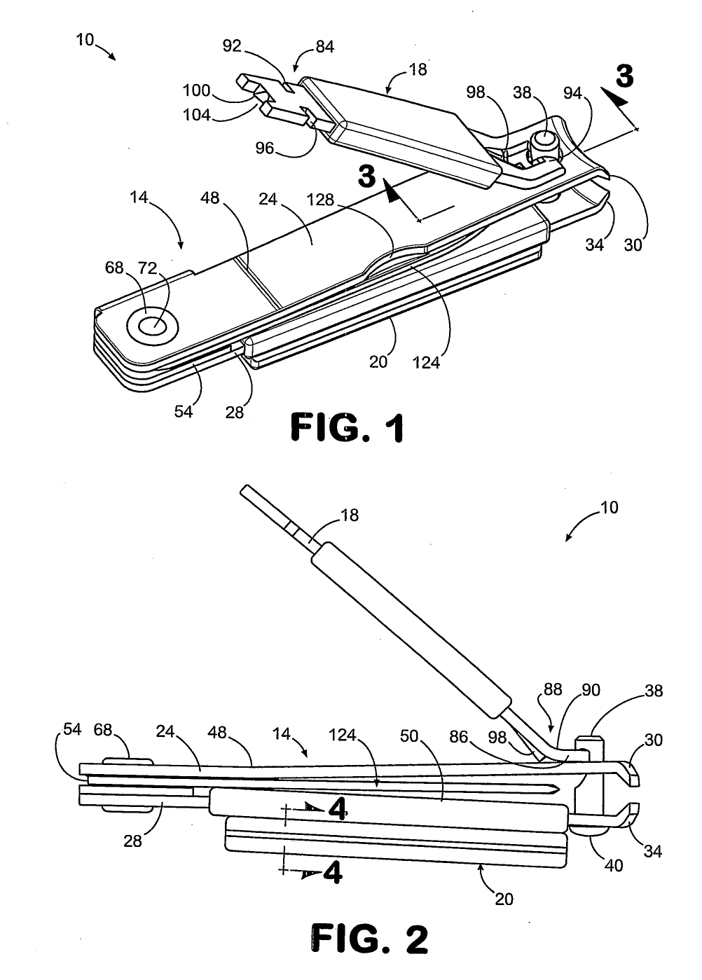

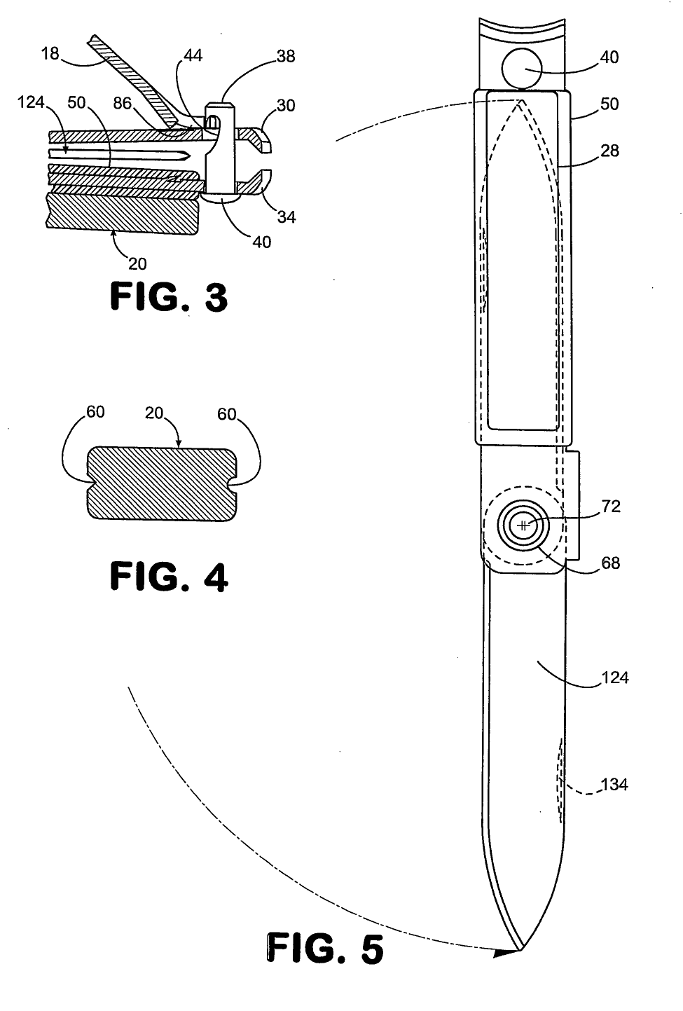

One embodiment of a utility tool that enables an angler to cut fishing line and sharpen hooks is shown in a perspective view in FIG. 1. The tool 10 includes an anvil component 14, a lever arm 18, and a sharpening stone 20. The anvil component 14 includes a first planar member 24 and a second planar member 28. The two planar members 24 and 28 terminate into jaws 30 and 34, respectively. Near the jaws, a fulcrum pin 38 extends through the planar members 24 and 28. The fulcrum pin 38 has a flange 40 (FIG. 2) at one end that abuts a lower surface of the planar member 28 to prevent the fulcrum pin from passing through the planar member 28. As shown in FIG. 3, the fulcrum pin 38 includes a pivot fitting 44. The fulcrum pin 38 is press fitted into an aperture near the jaw 34 in planar member 28 to secure the fulcrum pin 38 to the planar member 28.

The planar member 24 has a bend 48. The portion of the planar member 24 that extends from the bend 48 to the end in which the jaw 30 is formed diverges angularly from the planar member 28. This angular deviation enables the two jaws 30 and 34 to be separated from one another so material, such as fishing line may be placed between the jaws. Another portion of the planar member 24 extends from the bend 48 in a direction that is relatively parallel to the planar member 28. The parallel portions of the planar members 24 and 28 may be joined to one another. These parallel portions may be joined to one another using a rivet 68, as shown in FIG. 1, or they may be sonically welded or soldered together.

The portion of the planar member 28 that extends from the junction of the two parallel portions of the planar members 24 and 28 to a position near the edge of the flange 40 of the fulcrum pin 38 may be overlaid or wrapped in a covering layer 50. The covering layer provides a grip surface that is more easily grasped than a smooth surface. In one embodiment, the covering layer is made of neoprene, although other tacky materials may be used to facilitate gripping of the tool. The covering layer 50 may encircle a portion of the planar member 28 to help ensure the covering layer remains attached to the planar member 28. Alternatively, the covering layer may overlay only the lower surface of the planar member 28. In other embodiments, a covering layer 50 may overlay or be wrapped around a portion of the lever arm 18 as shown in FIG. 1 and FIG. 2. In the embodiment in which the covering layer 50 surrounds a portion of the planar member 28, a shim 54 may be placed between the two parallel portions of the planar members 24 and 28 to compensate for the thickness of the covering layer 50. The shim 54 may be as long as the parallel portions of the planar members 24 and 28.

The sharpening stone 20 may be a sedentary sharpening stone, commonly known as an Arkansas stone, or a manmade stone having a similar grit and abrasiveness. Such stones are available, for example, from Source International of Louisville, Ky., although other sources of natural and manmade stones may be used. As shown in FIG. 4, the sharpening stone 20 has a groove 60 that extends along at least one longitudinal edge of the stone 20. This groove facilitates the sharpening of hook ends in the groove. As depicted in the figure, the stone may be constructed with a groove along each longitudinal side of the stone. One of the grooves may be V-shaped while the other groove may be U-shaped, although other groove configurations and combinations may be used. The diversity in the shape of the grooves enables different types of strokes and repair actions to be taken with regard to hooks and other implements. While the stone 20 may be mounted to the lower surface of the planar member 28 with adhesive or the like, it is preferably mounted to the covering layer 50 by adhesive or the like.

The planar member 24 is shown in a side view in FIG. 2 with further attention to the mounting of the lever arm 18 in FIG. 3. The planar member 24 includes an aperture through which the fulcrum pin 38 may extend upwardly from the planar member. A rivet 68 may be used to join the planar member 24 to the planar member 28. Thus, the planar member 28 may also include an opening to receive the rivet 68. If a shim 54 is used in the construction of the anvil component 14, it may also include an opening to receive the rivet. The rivet 68 may also include an opening 72 to receive a lanyard or the like so the utility tool 10 may be secured to structure. Alternatively, the planar members 24 and 28 may be joined directly to one another or with a shim 54 interposed between them without using a rivet. In this embodiment, the planar members and shim may be formed with openings that are aligned before securing the components to one another to provide an opening for a lanyard or other securing member, such as a plastic tie or the like.

The lever arm 18 is shown in a side view in FIG. 2. The lever arm 18 includes a bend 90, which provides a support 86 for the lever arm when the arm is in position to leverage the two jaws towards one another as shown in the figures. The front portion 88 of the lever arm 18 also includes an opening 94 (FIG. 1) that fits within the fulcrum pivot fitting 44 (FIG. 3). A fulcrum rocker 98 provides a fulcrum point for leveraging the jaws towards one another as shown in FIG. 2. The rear portion 84 (FIG. 1) may include at least one and, preferably, two slots 92 and 96 that extend across a portion of the width of the lever arm 18. These slots may receive eyelets on lures or other screw mounted structures so the lever arm may be operated as a wrench to turn the eyelet or other screw mounted structure. If two slots are provided, they preferably have different widths to accommodate different gauge sizes of wire used to form eyelets or other screw mounted structure. A reamer 100 may extend from the rear of the lever arm 18. The reamer 100 is provided to open or widen eyelet openings or other line receiving structure. The reamer 100 may be implemented with a conical or triangular point. The reamer 100 may be located within a U-shaped recess 104, as shown in FIG. 1, to help center the eyelet or other structure for mating with the reamer 100. The U-shaped recess may also be used to disgorge hooks from fish.

The lever arm 18, the planar members 24 and 28, and the fulcrum pin 38 may be constructed from metal, such as cold rolled carbon steel or stainless steel. The metal may be finished with a corrosion resistant finish, such as a parkerized or anodized finish, as know in the metal treating art. Preferably, these components are not chrome plated. The covering layer may be neoprene or other foam or plastic material. The covering layer may be adhesively bound to the metal surfaces of the planar arm 28 or the lever arm 18. Although the embodiment depicted in the drawings includes a covering layer about the lever 18, the lever arm 18 may be provided without the layer in conjunction with the planar member 28 being at least partially encased in a covering layer.

While the embodiment depicted in the figures includes a knife blade 124, which is housed between the planar members 24 and 28, the tool 10 need not have a knife blade. In embodiments having a knife blade, the rivet 68 also passes through an orifice in one end of the knife blade 124 to form a pivot for the knife blade. The planar member 24 may have a curved recess 128 formed in it to provide access to a groove 134 or other structure that may be formed in the knife blade 124. The groove 134 may be grasped or otherwise engaged by a person's fingernail to further facilitate manipulation of the knife blade. One or the other planar members 24, 28 may also be formed with a tab or other structure on the side opposite the side in which the recess 128 is located to act as a stop. The stop helps keep the blade within the anvil 14 when it is not in use.

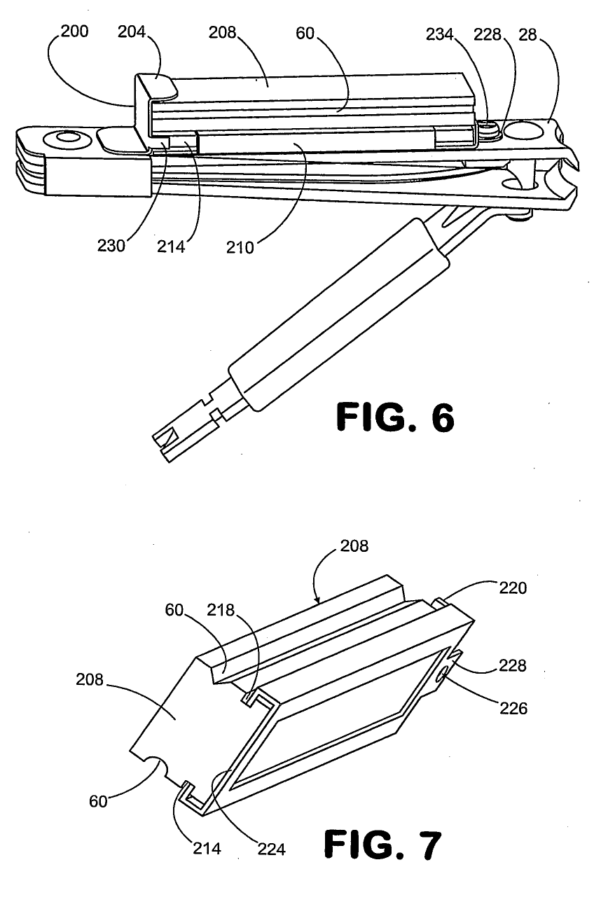

The embodiment described thus far depicts the sharpening stone 20 has been mounted to the covering layer 50. A preferred embodiment is shown in FIG. 6, in which the sharpening stone is mounted to a bracket that is selectively coupled to the tool. In the bottom perspective view of FIG. 6, a mounting bracket 200 is attached to the bottom of the planar member 28. The bracket 200 may be sonically welded or attached with a securing member, such as a rivet. The bracket 200 is generally L-shaped with the upper flange 204 being located from the bottom of the planar member 28 by a distance that is approximately equal to the thickness of the sharpening stone 208 and its holding bracket 210.

The sharpening stone 208 and holding bracket 210 are shown in FIG. 7. The sharpening stone 208 has two additional grooves 214 that are generally parallel to the grooves 60 that are used to repair and sharpen hooks and other tackle parts. The bracket 210 includes a pair of side walls that terminate in flanges 218. The grooves 214 of the sharpening stone receive flanges 218 of the bracket 210. One end 220 of the bracket 210 is open to enable the sharpening stone 208 to be inserted into the bracket 210. The other end 224 is closed to stop the stone 208. Adhesive is applied to the edges of the stone 208 between the bottom surface and the grooves 214 to secure the stone 208 within the bracket 210. The end 224 also includes a tab 228 that extends away from the stone. Tab 228 may include an opening 226 for a screw.

The sharpening stone 208 and bracket 210 are mounted to the tool by sliding the open end 220 of the bracket 210 against the bracket 200. Bracket 200 includes flanges 230 that are separated from one another by a distance approximately the width of the sharpening stone 208. The opening 226 is aligned with a threaded opening in the planar member 28. A screw 234 is then inserted and tightened in the opening 226 to secure the sharpening stone to the tool. The screw 234 may have a gripping adhesive, such as lock-tite, applied to the threads to help maintain the grip of the threads on the screw. The adhesive is preferably not permanent as the stone 208 and bracket 210 may be replaced as a unit. This structure enables a user to replace a worn or broken stone or to install a stone with a different finish or groove configuration. In embodiments in which a sharpening stone is permanently mounted with the bracket 210, the tab 228 may be provided without an opening for a screw and sonically welded or riveted to the planar member 28.

In operation, a tackle box may be provided with the utility tool or a lanyard secured to the tool may be used to secure the tool to a railing or other structure on a boat. When an angler wants to change lures or hooks, the tool may be retrieved and the lever arm 18 lifted, rotated approximately 180 degrees, and lowered so the support 86 contacts the planar member 24 as shown in FIG. 2. By depressing the outboard end of the lever arm 18 towards the planar member 24, the jaws 30 and 34 are urged towards one another to snip line or a knot inserted between the jaws. After the knot is snipped, the hook or lure may be removed and placed in the tackle box. The replacing hook or lure may then be sharpened by turning the tool 10 over to expose the sharpening stone 20. The point may be sharpened in the groove 60 while a hook barb may be sharpened on the flat surface of the stone. The tool may then be returned to the tackle box or left to be suspended from the lanyard after the sharpened hook or lure is tied to the fishing line and the line is trimmed from the knot. Thus, the tool 10 enables hooks and lures to be more easily replaced without requiring an angler to search through a tackle box for two independent tools and possibly dropping the hook or lure.

Those skilled in the art will recognize that numerous modifications can be made to the specific implementations described above. Therefore, the following claims are not to be limited to the specific embodiments illustrated and described above. The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. An angler's utility tool comprising:
a first planar member having a first end and a second end, the first end of the first planar member terminates into a jaw;
a second planar member having a first end and a second end, the first end of the second planar member terminates into a jaw, and the second ends of the first and the second planar members are joined to one another;
a fulcrum pin extending through the first ends of the first and the second planar members;
a lever arm pivotally and rotationally mounted to the fulcrum pin; and
a sharpening stone having a groove in a longitudinal edge of the sharpening stone, the sharpening stone being mounted to a bottom surface of the second planar member.

2. The utility tool of claim 1, the lever arm having a first slot that extends across a portion of a width of the lever arm;
the lever arm having a second slot that extends across a second portion of the width of the lever arm, the first and the second slots having different widths; and
the lever arm having a triangular projection within a U-shaped recess located at the second end of the lever arm.

3. The utility tool of claim 1 further comprising:
a bracket mounted to a surface of the sharpening stone, the sharpening stone being mounted to the second planar member with a securing member that engages the bracket and the second planar member.

4. An angler's utility tool comprising:
a first planar member having a first end and a second end, the first end of the first planar member terminates into a first jaw;
a second planar member having a first end and a second end, the first end of the second planar member terminates into a second jaw, and the second ends of the first and the second planar members are joined to one another;
a fulcrum pin extending through the first ends of the first and the second planar members;
a lever arm pivotally and rotationally mounted to the fulcrum pin, the lever arm having a fulcrum rocker located near the fulcrum pin to enable the lever arm to be moved to urge the first jaw and the second jaw towards one another; and
a sharpening stone mounted to a lower surface of the second planar member.

5. The utility tool of claim 4, the tool further comprising:
a cover over a portion of the second planar member between the first and the second ends of the second planar member, the cover being interposed between the sharpening stone and a lower surface of the second planar member.

6. The utility tool of claim 5 further comprising:
the sharpening stone having a groove in a longitudinal edge of the sharpening stone.

7. The utility tool of claim 5, the lever arm having a slot that extends across a portion of a width of the lever arm.

8. The utility tool of claim 7, the lever arm having a second slot that extends across a second portion of the width of the lever arm.

9. The utility tool of claim 5, the lever arm having a reamer extending from one end of the lever arm.

10. The utility tool of claim 9, the reamer being located within a U-shaped recess at the one end of the lever arm.

11. The utility tool of claim 4 further comprising:
a knife blade rotationally mounted between the first planar member and the second planar member.

12. An angler's utility tool comprising:
an anvil having at least one cutting edge to sever fishing line, the anvil having an upper and a lower surface; and
a sharpening surface mounted to the lower surface of the anvil.

13. The utility tool of claim 12, the tool further comprising:
a lever arm pivotally and rotationally mounted to the upper surface of the anvil;
the anvil further comprising:
a first jaw and a second jaw, the first and second jaws being urged together in response to the lever arm being rotated approximately 180 degrees from a position aligned with the anvil and then pivoted toward the anvil.

14. The utility tool of claim 12, the sharpening surface being a sharpening stone.

15. The utility tool of claim 14, the anvil having a covering layer applied to the lower surface; and
the sharpening stone is mounted to the covering layer.

16. The utility tool of claim 14, the sharpening stone having a groove in a longitudinal edge of the sharpening stone.

17. The utility tool of claim 13, the lever arm having a slot that extends across a portion of a width of the lever arm.

18. A replaceable sharpening stone for a utility tool comprising:
a bracket;
a sharpening stone mounted to the bracket; and
a tab extending from the bracket, the tab having an opening to receive a securing member to secure the bracket and the sharpening stone to a utility tool.

19. The replaceable sharpening stone of claim 18 wherein the bracket includes a pair of flanges and the sharpening stone includes a pair of longitudinal grooves that receive the flanges.

20. The replaceable sharpening stone of claim 19 wherein the bracket has a stop at one end to block the sharpening stone from sliding past the one end of the bracket.
